(19) United States
(12) Patent Application Publication
(10) Pub. No.: US 2007/0238491 A1
(43) Pub. Date: Oct. 11, 2007

(54) System and method for establishing wireless connections between user devices and vehicles

(75) Inventor: Bin He, Rolling Meadows, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC.

(21) Appl. No.: 11/394,426

(22) Filed: Mar. 31, 2006

(51) Int. Cl. H04B 1/034; H04B 1/18; H04M 1/00

(52) U.S. Cl. 455/569.2; 455/99; 455/152.1

(57) ABSTRACT

A system and method for a vehicle is disclosed. Memory stores user profiles for a plurality of users. Each of the user profiles includes setting inputs for vehicle components and includes a wireless connection identifier for a wireless user device. The user selects his user profile in a user interface. A controller receives the selection from the user interface and obtains the setting inputs and the wireless connection identifier form the selected user profile in memory. The controller initiates one or more commands to the vehicle components having obtained setting inputs. In addition, the controller initiates a wireless connection between the wireless vehicle device and the wireless user device of the user using the wireless connection identifier.

### FIELD OF THE DISCLOSURE

The subject matter of the present disclosure relates to a system and method for establishing wireless connection between a wireless user device and a wireless vehicle system.

### BACKGROUND OF THE DISCLOSURE

In some modern vehicles, users can store programmable profiles with settings for preferred seat positions, mirror angles, and steering wheel tilt. Once programmed, the driver can choose her profile by pressing a button on the side-panel of the driver's seat or other location. Once selected, the vehicle automatically adjusts the seat, mirrors, and steering wheel to reflect the preferred settings stored in her profile. In some modern vehicles, drivers can make and receive telephone calls hands-free using a hands-free system in the vehicle. To operate, the driver's wireless telephone must be paired to the hands-free system, which may use Bluetooth™ technology and may typically pair with only one telephone at a time. Using the hands-free system, the driver can place and answer calls and browse and select phonebook contacts stored on the telephone using controls located on parts of the vehicle, such as the vehicle's steering wheel, radio, or touch-screen display.

There are situations where several users may store preferred settings and may use wireless telephones in the same vehicle. For example, a husband and a wife may interchangeably ride as driver and passenger in their family car. Both of them may have preferred settings for seats, mirrors, etc., and both may have wireless telephones that they use while in the vehicle. Therefore, a need exists for a vehicle system that can handle preferred settings of several users in a vehicle and can handle wireless connection with the wireless telephones for those users when in the vehicle.

### BRIEF DESCRIPTION OF THE DRAWINGS

The foregoing summary, preferred embodiments, and other aspects of subject matter of the present disclosure will be best understood with reference to a detailed description of specific embodiments, which follows, when read in conjunction with the accompanying drawings, in which:

FIG. 1 illustrates a system for establishing a wireless connection between a wireless user device and a wireless vehicle device.

FIG. 2 illustrates the vehicle system of FIG. 1 coupled to an example of a user interface and an actuator.

FIG. 3 illustrates operation of the system of FIG. 1 in flowchart form.

While the subject matter of the present disclosure is susceptible to various modifications and alternative forms, specific embodiments thereof have been shown by way of example in the drawings and are herein described in detail. The figures and written description are not intended to limit the scope of the inventive concepts in any manner. Rather, the figures and written description are provided to illustrate the inventive concepts to a person skilled in the art by reference to particular embodiments, as required by 35 U.S.C. §112.

### DETAILED DESCRIPTION

Systems and methods for establishing a wireless connection between a wireless user device and a wireless vehicle system are disclosed. In an embodiment of a wireless connection method, setting inputs for a plurality of users are received for components in the vehicle. Some examples of vehicle components include adjustable seats, adjustable mirrors, steering wheel tilt mechanism, and others. In addition, wireless connection identifiers are received for wireless user devices of the users. Some examples of wireless user devices includes portable wireless devices, such as wireless telephones, music players, Personal Digital Assistances, navigation devices, and others.

The wireless connection identifiers and the setting inputs are then stored in user profiles for the user, and the user profile for one of the users is retrieved. To retrieve the profile, for example, a user can select her profile using a user interface. In another example, the driver of the vehicle may be automatically determined, and the user profile belonging to the driver of the vehicle may be retrieved. After the user profile is retrieved, one or more commands are initiated to vehicle components having setting inputs in the retrieved user profile. In turn, the vehicle components implement those settings based on the commands. In addition, a wireless connection is initiated between a wireless vehicle system and the wireless user device of the user using the wireless connection identifier in the retrieved user profile. In one example, the wireless connection is established between the user's wireless telephone and the vehicle's hands-free system using a unique wireless identifier, such as a unique Bluetooth™ identification number, for the user's telephone.

In an embodiment of a vehicle system, the system includes memory and a controller. The memory stores user profiles for a plurality of users. Each of the user profiles includes one or more setting inputs for one or more of the components of the vehicle. In addition, each of the user profiles includes a wireless connection identifier for a wireless user device of the user. The information in the user profile stored in memory can be previously configured by the users.

The controller is communicatively coupled to the memory, the one or more vehicle components, and a wireless vehicle system. The controller retrieves the user profile for one of the users. For example, the user can select her profile using a user interface coupled to the controller. In another example, the controller can automatically determine which user is the driver of the vehicle, and the controller can retrieve the user profile for the driver from memory.

From the user profile, the controller obtains the setting inputs and wireless connection identifier associated with the user. Based on the information in the user profile, the controller initiates one or more commands to vehicle components having setting inputs. In turn, the vehicle components implement those settings for the user based on the commands. In addition, the controller initiates a wireless connection between the wireless vehicle system and the wireless user device of the user using the wireless connection identifier. For example, the controller pairs a wireless telephone and a wireless hands-free system using the wireless connection identifier for the particular wireless telephone the user has established in her profile. The pairing procedure can use a wireless technology, such as Bluetooth™, Wi-Fi, or Ultra-Wideband.

The foregoing is not intended to summarize each potential embodiment or every aspect of the present disclosure. Let us now refer to the figures to describe the subject matter of the present disclosure in more detail.

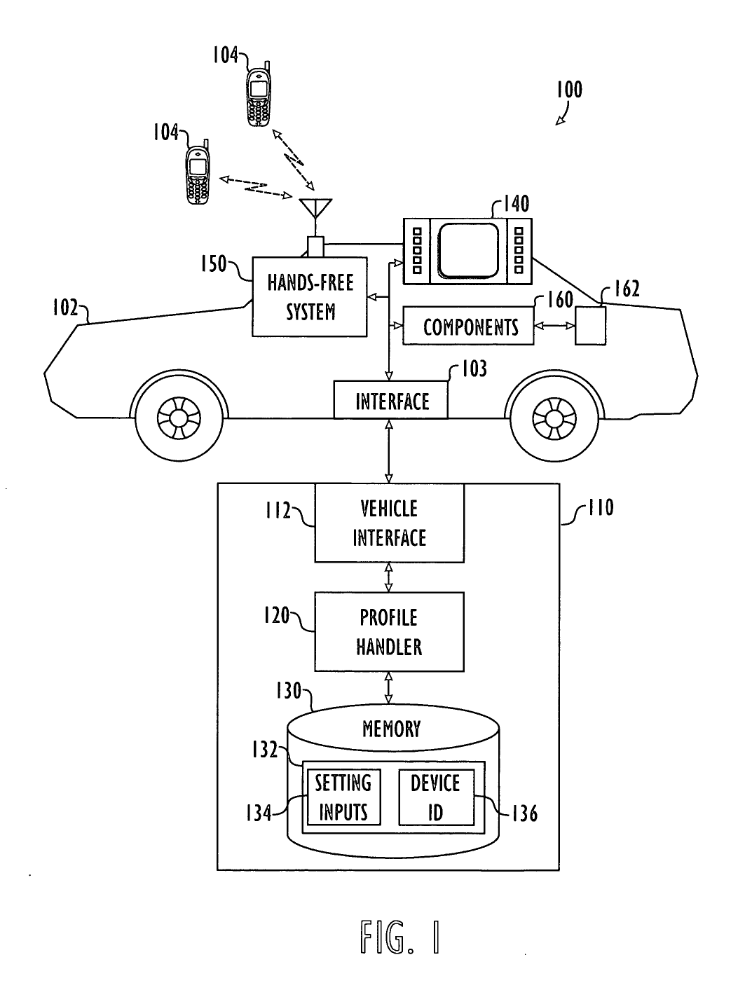

Referring to FIG. 1, a vehicle system 100 is schematically illustrated in a vehicle 102. The vehicle system 100 includes a controller 110, a profile selector or user interface 140, a wireless vehicle system 150, and vehicle components 160. The controller 110 has a control unit or profile handler 120 and memory 130.

In one embodiment, the vehicle system 100 is an integrated unit such that the controller 110 is integrally part of the user interface 140 and the wireless vehicle system 150. In another embodiment, the controller 110 can be an added component to the vehicle 102 and can be separate from the user interface 140 and the wireless vehicle system 150, which may already be part of the vehicle 102. To connect the controller 110 with other components, the controller 110 includes a vehicle interface 112 communicatively coupled to an interface 103 of the vehicle 102, which can be an On-Board Diagnostic connection, vehicle bus, or other vehicle interface known in the art.

The vehicle system 100 allows users to set and select preferred settings for vehicle components 160 and allows the users to set how the wireless vehicle system 150 establishes a wireless connection with wireless user devices 104. In the present embodiment, the wireless user devices 104 are wireless telephones, such as cellular phones or the like. In addition, the wireless vehicle system 150 of the present embodiment is a hands-free system that allows users to make and receive calls without handling their wireless telephones 104. In this context, the wireless connection established between the hands-free system 150 and the wireless telephones 102 can be based on any of a number of different wireless technologies, such as Bluetooth™. Details related to such wireless technologies and the wireless connection between the hands-free system 150 and wireless telephones 104 are known to those skilled in the art and are not discussed in detail herein.

As mentioned briefly above, the vehicle system 100 allows users to set and select preferred settings for vehicle components 160. Some examples of vehicle components 160 include power seats, automated mirrors, automated steering wheel tilt mechanism, an entertainment system, a hands-free system, a navigation system, a user interface, and other components in the vehicle 102. For example, various actuators (e.g, motors, servos, etc.) or controls 162 can control the position of vehicle components 160, such as automated mirrors and seats. The preferred settings for the vehicle components 160 are stored in memory 130 as setting inputs 134 that form part of a user profile 132. One or more users can have their user profiles 132 stored in memory 130 and can access their user profile 132 using the user interface 140.

To implement a user's preferred settings, for example, the user makes a selection with the user interface 140. In turn, the profile handler 120 of the controller 110 receives the selection and obtains the setting inputs 134 form the associated user profile 132 stored in memory 130. Then, the profile handler 120 initiates one or more commands to the vehicle components 160 to implement the setting inputs 134. In this way, the user, who can be a driver or passenger, can have the seat, mirrors, and other vehicle components 160 moved or set to her preferred settings. Other preferred settings that can be stored and retrieved in the user profile 132 include preferred radio stations, climate-control preferences, a setting for an entertainment system, a setting for a hands-free system, a setting for a navigation system, a setting for a user interface, and any other programmable feature offered in the vehicle 102.

As mentioned briefly above, the vehicle system 100 also allows users to set how the hands-free system 150 will establish a wireless connection with a wireless telephone 104. To implement the wireless connection, the user first associates a device ID 136 for her wireless telephone 104 with her preferred setting inputs 134 stored in the user's profile 132. In one embodiment, the device ID 136 is a unique Bluetooth™ identification number associated with the user's Bluetooth™-enabled wireless telephone 104. When the user subsequently selects her user profile 132 using the user interface 140, the profile handler 120 also obtains the device ID 136 and instructs the hands-free system 150 to connect automatically with the wireless telephone 104 associated with the stored device ID 136. Initiating the wireless connection can involve sending a command or message from the controller 110 to the hands-free system 150, and establishing the wireless connection between the hands-free system 150 and the wireless telephone 104 can use techniques known in the art.

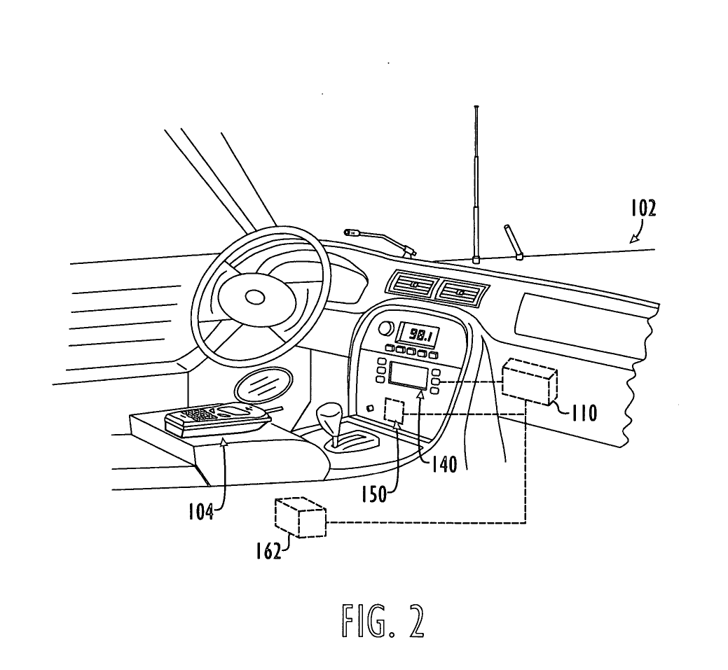

As discussed above, the user interface 140 can be used to set preferred settings for vehicle components 160 and to select which wireless telephone 104 to connect with. Referring to FIG. 2, an example of such a user interface 140 coupled to the controller 110 is illustrated. The user interface 140 in this example is a dashboard unit installed in the vehicle 102 and can be part of a navigation unit or the like. To set the preferred settings, the user adjusts the vehicle components, such as seats and mirrors (not shown), to her preferred position or setting, the user then presses buttons located on the user interface 140 to set the settings, and the controller 110 stores the setting inputs in the user's profile.

To set the wireless telephone 104, the user first teaches the wireless telephone 104 to communicate with the hands-free system 150 by exchanging unique wireless identifiers between the wireless telephone 104 and the hands-free system 150. For example, the wireless telephone 104 and the hands-free system 150 can be Bluetooth™-enabled. Using Bluetooth™ technology and techniques known in the art, the user instructs her wireless telephone 104 to detect other Bluetooth™-enabled devices, and the wireless telephone 104 displays a list of Bluetooth™-enabled devices within its range. From the list, the user selects the unique Bluetooth™ ID for the hands-free system 150 in the vehicle 102. Then, the wireless telephone 104 prompts the user to enter a passkey, which is typically provided by the manufacturer of the hands-free system 150. Once the passkey is entered, the wireless telephone 104 is paired to the hands-free system 150. The user then associates the paired telephone 104 with her profile in the controller 110 using buttons on the user interface 140. Once set, the device ID (e.g., unique Bluetooth™ ID or other unique wireless identifier) of the wireless telephone 104 is stored in memory as part of the user's profile.

In one advantage of the vehicle system 100 of FIG. 1, users do not have to repeat a pairing procedure between their wireless telephones 104 and the hands-free system 150 each time they wishes to establish a wireless connection because the device IDs 136 are stored along with the preferred setting inputs 134 in the user profiles 132. In addition, the users can initiate the wireless connection and their preferred settings for components 160 each time they enter the vehicle 110 simply by selecting their profile 132 using the user interface 140.

Another advantage of the vehicle system 100 is shown in FIG. 1. For example, two or more users may have active wireless telephones 104 in range of the hands-free system 150 at the same time. One of the wireless telephones 104 may belong to the current driver, while the other telephone 104 may belong to a passenger. Both of these wireless telephones 104 may already be “recognized” by the hands-free system 150. In other words, both of these wireless telephones 104 may have been previously paired with the hands-free system 150 in the past so that the system 150 knows the device IDs 136 for the telephones 104. In addition, both of these users may have already set preferred setting inputs 134 for vehicle components 160. In this situation, the controller 110 preferably instructs the hands-free system 150 to establish a wireless connection with the wireless telephone 104 associated with the driver, because the driver is the person in the vehicle 102 who will have the most benefit of using the hands-free system 150.

As noted previously, users can select which of them is the current driver of the vehicle 102 using the user interface 140. Based on the selection, the vehicle system 100 obtains the setting inputs 134 and device IDs 136 for the users from their profiles 132 and takes appropriate actions by setting the vehicle components 160 for the users and establishing wireless connection with the driver's telephone 104. In another embodiment, the vehicle system 110 uses automated forms of operation rather than depending on manual selection by users with the user interface 140. For example, the vehicle system 100 automatically detects which recognized wireless telephones 104 are active in range of the hands-free system 150, and the controller 110 uses the device IDs 134 from the detected telephones 104 to obtain associated user profiles 132 from memory 130. In addition, the controller 110 uses information from the user profiles 132 to determine automatically which user of a detected telephone 104 is the current driver of the vehicle 102.

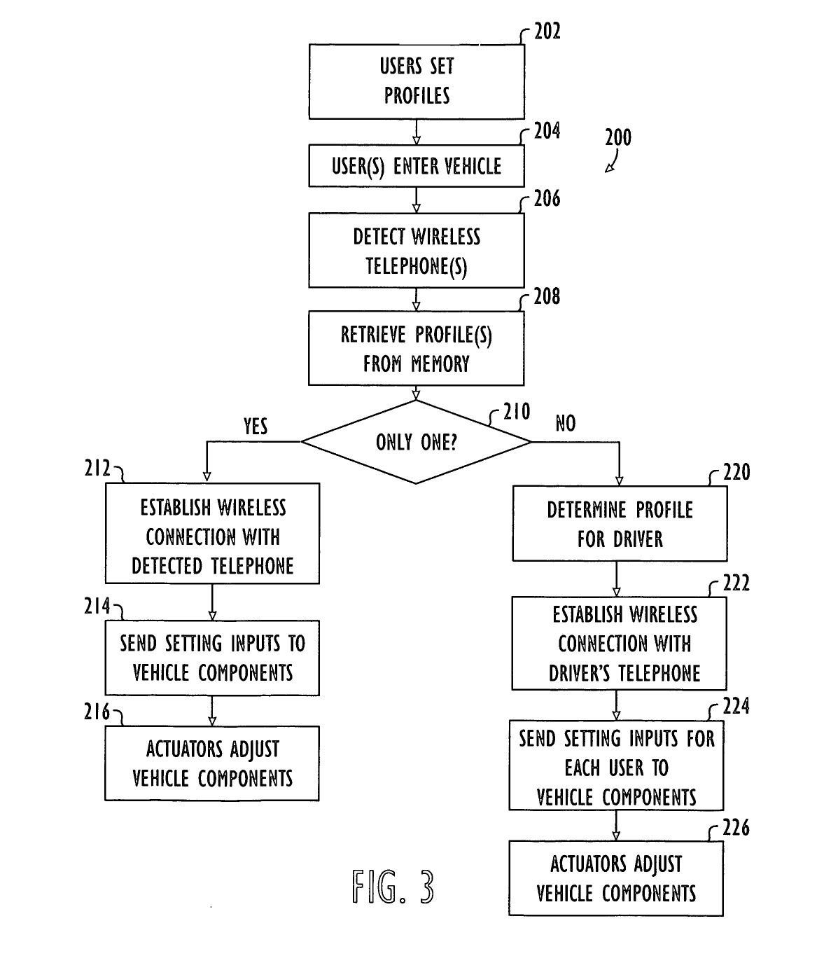

Referring to FIG. 3, for example, steps 200 for some of the above-mentioned forms of automated operation by the vehicle system 100 of FIG. 1 are illustrated in flow chart form. In the discussion that follows, reference is concurrently made with respect to element numerals for components of FIG. 1 for the sake of explanation. First, users set their profiles 132 by entering preferred setting inputs 134 and setting the device IDs 136 using the techniques discussed previously (Block 202). When one or more users subsequently enter the vehicle 102 with active wireless telephones 104 (Block 204), the hands-free system 150 detects the unique device IDs (e.g., unique Bluetooth™ IDs or other wireless identifiers) of the wireless telephones 104 within range and sends that information to the controller 110 (Block 206). Then, the profile handler 120 at the controller 110 accesses the user profiles 132 stored in memory 130 based on the detected device IDs 136 (Block 208).

If only one wireless telephone 104 has been detected (Block 210), the profile handler 120 may assume that the user of the detected wireless telephone 104 is the current driver of the vehicle 102. Accordingly, the controller 110 establishes wireless connection with the driver's detected wireless telephone 104 (Block 212). In addition, the controller 110 sends the driver's preferred setting inputs 134 to the vehicle components 160 appropriate for the driver (Block 214), and the actuators and other controls 162 adjust the vehicle components 160 accordingly (Block 216).

The assumption by the controller 110 that the one detected telephone 104 belongs to the driver may be incorrect. For example, the detected telephone 104 may actually belong to a passenger, and the driver may not have her telephone 104 or it may be turned off. Therefore, the controller 110 may allow the users to verify or override the assumption using the user interface 140. In one embodiment, the controller 110 may determine from seat sensors (not shown) how many people are sitting in the vehicle 102. If only one person is detected and only one wireless telephone 104 is detected, then that person is most likely the current driver of the vehicle 102. Therefore, the need for manual verification or override with the user interface 140 may be unnecessary. On the other hand, if seat sensors indicate that both the driver's seat and the front passenger's seat are occupied, then the need for manual verification or override with the user interface 140 may be necessary, especially if only one wireless telephone 104 is detected.

If more than one wireless telephone 104 has been detected (Block 210), then the profile handler 120 at the controller 110 determines which user profile 132 belongs to the current driver (Block 220). In one embodiment to determine the driver, the profile handler 120 accesses predefined designations about the users in the user profiles 132. The predefined designation may indicate which profile 132 is associated with a designated driver of the vehicle 102. Thus, if only one of the detected wireless telephones 104 is associated with a user designated as a driver while the others are not, the profile handler 120 may assume that this one wireless telephone 104 belongs to the current driver and can take the appropriate actions detailed below.

In another embodiment to determine the driver at Block 220, the profile handler 120 can access stored histories about the users in the user profiles 132. The stored histories may indicate which user is most likely to be the current driver of the vehicle 102. For example, the stored history for one of the user profiles 132 may indicate that the associated user has been the driver of the vehicle 102 for a higher percentage of times than the other users having detected telephones 104. Based on the determination from the histories, the profile handler 120 may assume that the wireless telephone 104 belonging to the more likely user is the current driver and can take the appropriate actions detailed below.

In yet another embodiment to determine the driver at Block 220, the profile handler 120 can require the users in the vehicle 102 to select which one of them is the current driver using the user interface 140. Requiring the users to select from the user interface 140 can be used initially to determine the current driver or can be used if the other determinations disclosed above are unable to determine the current driver.

Once the current driver is determined at Block 220, the controller 110 instructs the hands-free system 150 to establish wireless connection with the unique device ID 136 associated with the determined driver because the driver is more likely to benefit from the features of the hands-free system 150 (Block 222). However, the controller 110 may allow the users in the vehicle 102 to override this wireless connection using the user interface 140.

The controller 110 then retrieves the setting inputs 134 associated with the unique device IDs 136 of the detected telephones 104 and sends the setting inputs 134 for each of the users to the appropriate vehicle components 160 (Block 224). The actuators or controls 162 then adjust the vehicle components 160 based on the setting inputs 134 (Block 226). For example, the setting inputs 134 for the determined driver are sent to those vehicle components 160 appropriate for the driver, such as the driver's seat, steering wheel tilt mechanism, hands-free system, 0etc. The setting inputs 134 for the other users are sent to those vehicle components 160 appropriate for passengers. If a seat sensor detects a front seat passenger and there is only one other detected wireless telephone 104 besides that of the driver, for example, the controller 110 may assume that the associated user of the other detected telephone 104 is the front seat passenger. In this situation, the controller 110 can send that user's preferred seat settings to the actuators 162 for the passenger seat of the vehicle 102.

The foregoing description of preferred and other embodiments is not intended to limit or restrict the scope or applicability of the inventive concepts conceived of by the Applicant. For example, the embodiment of the system 100 disclosed above has been described in conjunction with wireless telephones, such as cellular phones, for the wireless user devices 104. In addition, the embodiment of the system 100 disclosed above has been described in conjunction with a hands-free system as the wireless vehicle system 150. In addition to wireless telephones 104, it will be appreciated with the benefit of the present disclosure that the vehicle system 100 can be used with other wireless user devices 104, including, but not limited to, other wireless communication devices, wireless portable devices (e.g., Personal Digital Assistants), wireless e-mail devices (e.g., Blackberry), wireless portable audio devices (e.g., portable music players), wireless portable video devices, and wireless navigation devices. In addition to hands-free systems 150, it will also be appreciated that the vehicle system 100 can also be used with other wireless vehicle systems 150, including, but not limited to, other communication systems, entertainment systems, and navigation systems. In exchange for disclosing the inventive concepts contained herein, the Applicant desires all patent rights afforded by the appended claims. Therefore, it is intended that the appended claims include all modifications and alterations to the full extent that they come within the scope of the following claims or the equivalents thereof.

What is claimed is:

1. A wireless connection method, comprising:
receiving one or more setting inputs for one or more vehicle components;
receiving wireless connection identifiers for wireless user devices;
storing the wireless connection identifiers and the setting inputs in user profiles for a plurality of users;
retrieving the user profile for one of the users;
initiating one or more commands to vehicle components having setting inputs in the retrieved user profile; and
initiating a wireless connection between a wireless vehicle system and the wireless user device of the one user using the wireless connection identifier in the retrieved user profile.

2. The method of claim 1, wherein the one or more setting inputs for the one or more vehicle components are selected from the group consisting of a vehicle seat position, a mirror position, a steering wheel tilt, a setting for an entertainment system, a setting for a hands-free system, a setting for a navigation system, a setting for a vehicle climate system, and a setting for a user interface.

3. The method of claim 1, wherein the wireless user device is selected from the group consisting of a wireless communication device, a wireless telephone, a wireless portable device, a wireless e-mail device, a wireless portable audio device, a wireless portable video device, and a wireless navigation device.

4. The method of claim 1, wherein the wireless vehicle system is selected from the group consisting of a communication system, a hands-free system, an entertainment system, and a navigation system.

5. The method of claim 1, wherein retrieving the user profile for one of the users comprises receiving a user input from a user interface.

6. The method of claim 1, wherein retrieving the user profile for one of the users comprises:
automatically detecting a wireless user device within range of the wireless vehicle system, and
retrieving the user profile having the wireless connection identifier associated with the detected wireless user device.

7. The method of claim 1, wherein retrieving the user profile for one of the users comprises:
automatically determining a driver of the vehicle, and
retrieving the user profile for the determined driver.

8. The method of claim 7, wherein automatically determining a driver of the vehicle comprises:
detecting wireless user devices within range of the wireless vehicle system;
comparing histories or designations associated with the detected wireless user devices; and
selecting one of the users as the driver based on the comparison.

9. The method of claim 1, wherein:
the wireless user device comprises a wireless telephone,
the wireless connection identifier comprises unique wireless identification number for the wireless telephone, and
the wireless vehicle system comprises a wireless hands-free system.

10. The method of claim 9, wherein initiating a wireless connection between a wireless vehicle system and the wireless user device of the user using the wireless connection identifier in the user profile comprises pairing the wireless telephone with the hands-free system.

11. A system for a vehicle having a wireless vehicle system and one or more vehicle components, the system comprising:
memory for storing user profiles for a plurality of users, each of the user profiles including one or more setting inputs for one or more of the components of the vehicle and including wireless connection identifiers for wireless user devices of the users;
a controller communicatively coupled to the memory, the one or more vehicle components, and the wireless vehicle system, the controller configured to:
retrieve the user profile for one of the users;
obtain the setting inputs and wireless connection identifier form the selected user profile in memory;
initiate one or more commands to vehicle components having obtained setting inputs; and
initiate a wireless connection between the wireless vehicle system and the wireless user device of the user using the wireless connection identifier.

12. The system of claim 11, wherein the one or more setting inputs for the one or more vehicle components are selected from the group consisting of a vehicle seat position, a mirror position, a steering wheel tilt, a setting for an entertainment system, a setting for a hands-free system, a setting for a navigation system, a setting for a vehicle climate system, and a setting for a user interface.

13. The system of claim 11, wherein the wireless user device is selected from the group consisting of a wireless communication device, a wireless telephone, a wireless portable device, a wireless e-mail device, a wireless portable audio device, a wireless portable video device, and a wireless navigation device.

14. The system of claim 11, wherein the wireless vehicle system is selected from the group consisting of a communication system, a hands-free system, an entertainment system, and a navigation system.

15. The system of claim 11, further comprising a user interface for receiving a selection, wherein to retrieve the user profile for one of the users, the controller is configured to receive a selection from the user interface selecting the user profile of the user.

16. The system of claim 11, wherein to retrieve the user profile for one of the users, the controller is configured to:
automatically detect a wireless user device within range of the wireless vehicle system, and
retrieve the user profile having the wireless connection identifier associated with the detected wireless user device.

17. The system of claim 11, wherein to retrieve the user profile for one of the users, the controller is configured to:
automatically determine a driver of the vehicle, and
retrieve the user profile for the determined driver.

18. The system of claim 17, wherein to automatically determine a driver of the vehicle, the controller is configured to:
detect wireless user devices within range of the wireless vehicle system;
compare histories or designations associated with detected wireless user devices; and
select one of the users as the driver based on the comparison.

19. The system of claim 11, wherein:
the wireless user device comprises a wireless telephone,
the wireless connection identifier comprises unique wireless identification number for the wireless telephone, and
the wireless vehicle system comprises a wireless hands-free system.

20. The system of claim 19, wherein to initiate a wireless connection, the controller is configured to instruct the hands-free system to pair with the wireless telephone having the unique wireless identification number.
